(19) United States
(12) Patent Application Publication
(10) Pub. No.: US 2026/0212175 A1
(43) Pub. Date: Jul. 23, 2026

(54) TRAINING MODULAR AGENT NETWORKS USING LAYOUT DATA

(71) Applicant: DeepMind Technologies Limited, London (GB)

(72) Inventors: Tamara Louise von Glehn, Cambridge (GB); Jovana Mitrovic, London (GB); Hamza Merzic, London (GB); Alaa Saade, Montreuil (FR); Timothy Anthony Julian Scholtes, London (GB); Andre Saraiva Nobre dos Santos, London (GB)

(21) Appl. No.: 19/138,995

(22) PCT Filed: Dec. 13, 2023
(86) PCT No.: PCT/EP2023/085715

§ 371 Date: Jun. 13, 2025

Related U.S. Application Data
(60) Provisional application No. 63/432,370, filed on Dec. 13, 2022.

(51) Int. Cl. G06N 3/08

(52) U.S. Cl. CPC G06N 3/08

(57) ABSTRACT

Methods, systems, and apparatus, including computer programs encoded on a computer storage medium, for training an action selection neural network.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a training system implemented as computer programs on one or more computers in one or more locations that trains an action selection neural network used to control an agent that is interacting with an environment.

As used throughout this specification, a computing unit may be, e.g., a computer, a core within a computer having multiple cores, or other hardware or software, e.g., a dedicated thread, within a computer capable of independently performing operations. The computing units may include processor cores, processors, microprocessors, special-purpose logic circuitry, e.g., an FPGA (field-programmable gate array) or an ASIC (application-specific integrated circuit), or any other appropriate computing units. In some examples, the computing units are all the same type of computing unit. In other examples, the computing units may be different types of computing units. For example, one computing unit may be a central processing unit (CPU) while other computing units may be graphics processing units (GPUS).

As used throughout this specification, a trajectory refers to data characterizing interaction of an agent with an environment over a sequence of one or more time steps. More specifically, for each time step in a sequence of time steps, a trajectory can include data identifying: (i) an observation characterizing the state of the environment at the time step, (ii) an action performed by the agent at the time step, and (iii) a reward received at the time step. A trajectory can represent other data as well, e.g., a discount factor for each time step, a state of an action selection neural network being used to control the agent at each time step (e.g., where the state can be a hidden state of a recurrent action selection neural network, e.g., a cell state of a long short-term memory (LSTM) network), or both. Different types of trajectories can represent different additional data, i.e., different data in addition to observation-action reward tuples or can represent the same additional data differently.

As used throughout this specification, a “reinforcement learning technique” can refer to any appropriate reinforcement learning training technique, e.g., a Q learning technique or a policy gradient technique. Training an action selection neural network using a reinforcement learning technique can refer to backpropagating gradients of a reinforcement learning objective function through the action selection neural network to adjust the parameter values of the action selection neural network. Training an action selection neural network using a reinforcement learning technique can increase a cumulative measure of rewards (e.g., a time-discounted sum of rewards) received by an agent by performing actions selected using the action selection neural network.

In one particular example described herein, a method performed by one or more data processing apparatus for training a neural network for use in controlling an agent interacting with an environment comprises obtaining a first training data set, the first training data set comprising a plurality of first actor trajectories generated according to a first actor trajectory layout; receiving a training request for training the neural network, the training request comprising layout data specifying a learner trajectory layout; generating a second training data set by modifying each first actor trajectory based on the layout data to have the learner trajectory layout; and providing the second training data set for use in training the neural network.

Providing the second training data set for use in training the neural network may comprise storing the second training data set in a replay memory. The first training data may be stored in a replay memory. Generating a second training data set may comprise sampling, from the replay memory, a batch of first actor trajectories from the first training data set; and modifying each first actor trajectory in the batch based on the layout data to have the learner trajectory layout.

Obtaining a first training data set may comprise, for each of one or more actor engines, repeatedly performing operations comprising: controlling an instance of the agent to interact with the environment using an instance of the neural network; and generating a corresponding first actor trajectory based on the interaction of the instance with the environment. The method may further comprise repeatedly performing, for each of one or more learner engines, operations comprising: obtaining a batch of first actor trajectories; and training the neural network on the batch of first actor trajectories to minimize a loss function. The training request may specify: an unroll that comprises neural network components of the neural network to be deployed on both the one or more learner engines and the one or more actor engines. The unroll, when deployed on the one or more actor engines, may perform operations to generate an actor output for controlling the instance of the agent from an observation characterizing a state of the environment. The unroll, when deployed on the one or more learner engines, may perform operations to generate a learner output for evaluating the loss function. The training request may specify: a loss component that is deployed on the one or more learner engines and that receives an input comprising the learner output from the unroll deployed on the learner engine and determines an update to parameters of the neural network. The training request may designate, as pre-compute values, a subset of values that are computed by the unroll when deployed on the actor engines to generate an actor output. The unroll, when deployed on the actor engines, may store the pre-compute values as part of the actor trajectory. The unroll, when deployed on the learner engines, may access the pre-compute values rather than re-computing corresponding values while generating learner outputs. The unroll, when deployed on the actor engines, may operate on each received observation independently to generate a respective actor output for each observation. The unroll, when deployed on the learner engines, may operate on a plurality of time steps from each learner trajectory jointly to generate a learner output for the plurality of time steps.

The method may further comprise obtaining a third training data set, the third training data set comprising a plurality of third actor trajectories generated according to a third, different actor trajectory layout; generating a fourth training data set by modifying each third actor trajectory based on the layout data to have the learner trajectory layout; and providing the fourth training data set for use in training the neural network.

The training request may further specify a respective architecture of one or more components of the neural network.

Particular embodiments of the subject matter described in this specification can be implemented so as to realize one or more of the following advantages.

This specification describes a system for deploying modular agent networks for controlling agents in an environment. The system implements a framework that separates different components of the functionality required to train, design, or operate an action selection neural network into independent, interchangeable modules. For example, the system can be a training system for training action selection neural networks or other machine learning models that are used to control agents interacting with an environment. This allows the same system to be used to train multiple different action selection neural networks that have different architectures and allows for training components to be modified in order to improve the understandability and the testability of different aspects of the training process.

Moreover, the system can make use of layout data and unrolls as described below to significantly increase the amount of computation re-use between actors and learners within the system and, more generally, to significantly decrease the amount of data that needs to be transmitted between actors and learners during the training. Further, layout data and unrolls allow the system to off-load a significant amount of the computation that would conventionally need to be performed by the learner to the actor computing units within the system, reducing bottlenecks during training.

By treating all modules as components of an unroll and using ‘precompute’, the system can localize and encapsulate functionalities that are logically and mathematically grouped together. Modularity then allows the system to easily swap around components, e.g. change from no memory, to recurrent memory, to transformer memory without having to change any other part of the architecture. This enables faster collaboration, split of responsibilities, and better testability and robustness guarantees.

Additionally, layout data can be used to allow one learner to train an action selection neural network on multiple different types of data, e.g., on data generated using actor computing units controlled by the system, off-line data generated by other systems, or both. Layout data can also be used to allow one learner to train an action selection neural network using multiple different types of loss functions, e.g., a combination of two or more of reinforcement learning, supervised learning, or unsupervised learning.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that shows an example action selection system.

FIG. 2 shows an example training system.

FIG. 3A illustrates one example of an actor engine and a learner engine.

FIG. 3B illustrates another example of an actor engine and a learner engine.

FIG. 3C illustrates an example flow of data between actor engines and learner engines.

FIG. 4 illustrates an example of training an action selection neural network on multiple different data sets.

FIG. 5 is a flow diagram of an example process for training an action selection neural network.

FIG. 6 is a flow diagram of an example process for configuring a modular unroll.

Like reference numbers and designations in the various drawings indicate like elements.

### DETAILED DESCRIPTION

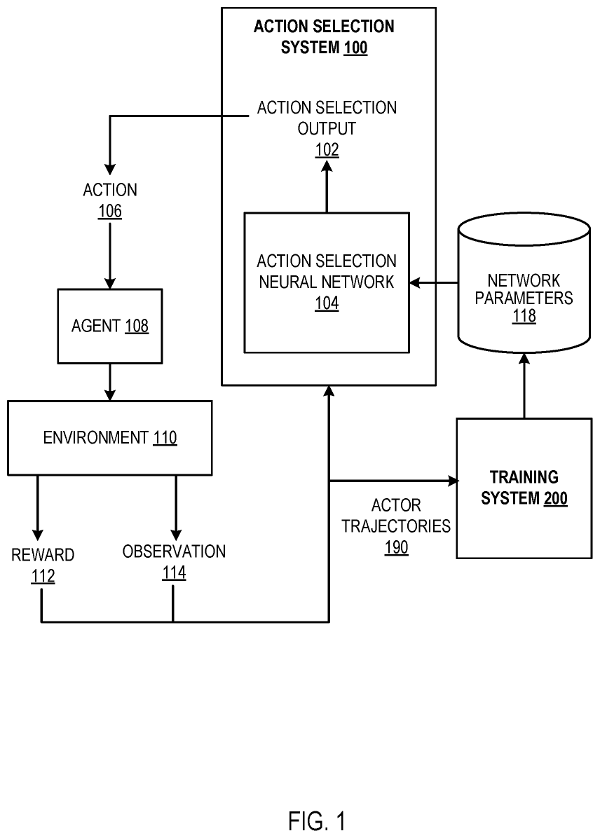

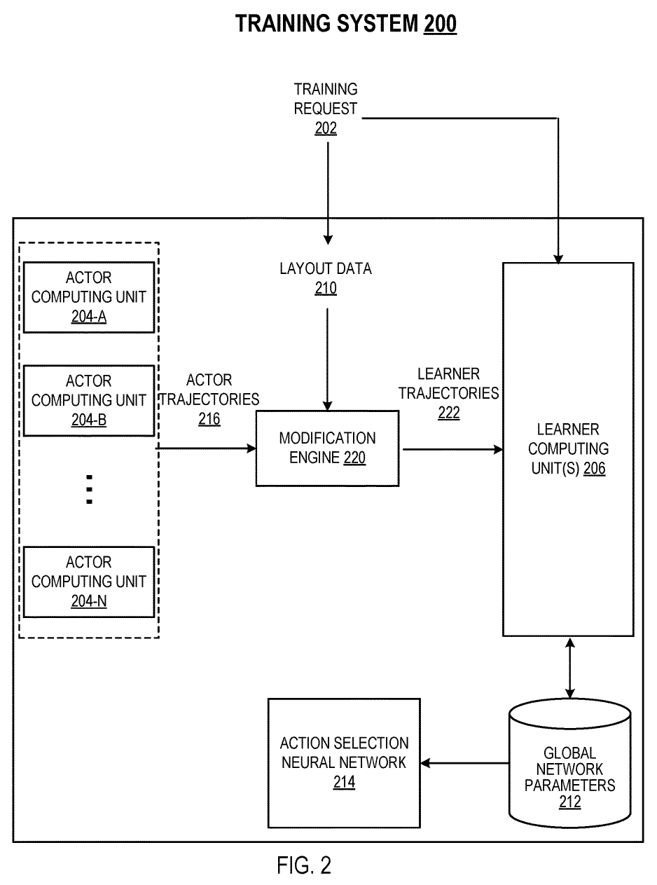

This specification describes a training system that implements a framework for training machine learning models, e.g., neural networks, that are used to control agents interacting with environments, e.g., used to select actions to be performed by an agent to interact with an environment. For example, a neural network (referred to as an “action selection neural network”) that is trained by the training system can be used by an action selection system to control an agent interacting with an environment. An example of an action selection system is described in more detail with reference to FIG. 1, and an example of a training system is described in more detail with reference to FIG. 2.

It is to be understood that references in this specification to controlling agents includes control of any type of physical (i.e. real-world) agent. The agent may be a mechanical agent, e.g., an autonomous vehicle, a control system for an industrial facility, e.g., a data center or a power grid, an individual actuator or multiple distributed actuators. The physical agent may be electrical. For example, techniques described in this specification can be used to train agents to control generation of voltages or currents within one or more components of a system, e.g., controlling lamps such as LEDs or X-rays, controlling generation of an electromagnetic field, or any control of other electrical component. For example, sensors may monitor a condition of a subject within an X-ray machine, such as a human or animal patient, and the machine learning modes may control the generation of X-rays within the X-ray machine.

The techniques described in this specification can also be used to train machine learning models to control software agents, e.g., that control a simulated robot or vehicle in a virtual environment or that control user interfaces.

A software agent may be controlled based on real-world inputs, such as sensor data from real-world sensors or based on virtual inputs, e.g., outputs from virtual sensors which obtain inputs from a virtual environment. Similarly, a real-world agent may be controlled based on real-world inputs or virtual inputs. A virtual environment may be constructed based on real-world inputs. For example, sensor data relating to interactions in a real-world environment may be obtained and that sensor data may be used to create a virtual environment.

The trained neural networks may receive inputs that include an observation characterizing the state of the environment being interacted with by the agent and the output of the machine learning mode can define an action to be performed by the agent in response to the observation, e.g., an output that defines a probability distribution over possible actions to be performed by the agent. The observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In other words, the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

The actions may be control inputs to control the robot, e.g., torques for the joints of the robot or higher-level control commands, or the autonomous or semi-autonomous land, air, sea vehicle, e.g., torques to the control surface or other control elements of the vehicle or higher-level control commands.

In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment.

FIG. 1 is a block diagram that shows an example action selection system 100. The action selection system 100 is an example of a system implemented as computer programs on one or more computers in one or more locations in which the systems, components, and techniques described below are implemented.

The action selection system 100 selects actions 106 to be performed by an agent 108 interacting with an environment 110 at each of multiple time steps to accomplish a goal. At each time step, the system 100 receives data characterizing the current state of the environment 110, e.g., an image of the environment 110, and selects an action 106 to be performed by the agent 108 in response to the received data. Data characterizing a state of the environment 110 will be referred to in this specification as an observation 114. At each time step, the state of the environment 110 at the time step (as characterized by the observation 114) depends on the state of the environment 110 at the previous time step and the action 106 performed by the agent 108 at the previous time step.

At each time step, the system 100 may receive a reward 112 based on the current state of the environment 110 and the action 106 of the agent 108 at the previous time step. Generally, the reward 112 may be a numerical value. The reward 112 can be based on any event in or aspect of the environment 110. For example, the reward 112 may indicate whether the agent 108 has accomplished a goal (e.g., navigating to a target location in the environment 110) or the progress of the agent 108 towards accomplishing a goal.

The action selection system 100 selects the action 106 to be performed by the agent 108 at each time step using an action selection neural network 104. More specifically, at each time step, the action selection system 100 provides an input that includes an observation characterizing the current state of the environment at the time step to the action selection neural network 104. The action selection neural network 104 processes the input, in accordance with values of a set of action selection neural network parameters 118, to generate an action selection output 102.

In some implementations, the action selection output 102 includes a respective score for each action in a set of possible actions that can be performed by the agent.

In some other implementations, the action selection output 102 directly defines an action to be performed by the agent, e.g., by defining a respective torque to be applied to each of one or more joints of a robotic agent, or by defining steering and acceleration actions to be performed by an autonomous vehicle agent.

The action selection system 100 selects the action 106 to be performed by the agent 108 at each time step using the action selection output 102 generated by the action selection neural network 104 at the time step in accordance with an action selection policy.

For example, the action selection system 100 can select the action using a greedy policy that selects the action having the highest score, according to the action selection output 102, as the action to be performed by the agent at the time step.

As another example, the action selection system 100 selects the action to be performed by the agent in accordance with an exploration policy that implements an exploration strategy for exploring the environment. For example, the action selection system 100 can use an e-greedy exploration strategy. In this example, the action selection system 100 can select the action having a highest score (according to the action selection output 102) with probability 1−ϵ, and select an action randomly with probability ϵ, where ϵ is a number between 0 and 1.

As another example, the action selection system 100, instead of directly using the action selection output to select the action at a given time step, performs, using the action selection neural network, a look-ahead search of the state space of the environment and uses the results of the look-ahead search to select the action. For example, the look-ahead search can be a Monte Carlo Tree Search (MCTS) that is guided by the action selection neural network. Examples of such look-ahead search techniques include the AlphaZero and MuZero techniques.

The action selection neural network 104 can have any appropriate neural network architecture that enables it to perform its described functions. For example, the action selection neural network can include any appropriate types of neural network layers (e.g., convolutional layers, fully connected layers, attention layers, recurrent layers, e.g., long short-term memory layers, etc.) in any appropriate numbers (e.g., 5 layers, 25 layers, or 125 layers) connected in any appropriate configuration (e.g., as a linear sequence of layers).

In some cases, the action selection neural network makes use of information characterizing previous interactions of the agent (or of another agent) with the environment when selecting the action at any given time step. In other words, the action selection neural network uses a “memory” to incorporate the previous interactions into the processing of the current observation.

As a particular example, the action selection neural network can include one or more recurrent neural network layers, e.g., LSTM layers, GRU layers, and so on. In these examples, the hidden states of these recurrent neural network layers that are updated at each time step serve as the memory.

As another particular example, while processing the current observation, the action selection neural network can read data from an episodic memory or a different type of memory structure that stores data relating to previous interactions. As a particular example of this, the action selection neural network can include one or more self-attention layers that self-attend over at least a representation of the current observation and representations of previous observations. In these implementations, the representations of these previous observations can serve as the memory that is used to incorporate the previous observations into the processing of the current observation.

For convenience, this specification generally refers to an action selection neural network. More generally, however, any appropriate machine learning model can be used to select actions to be performed by an agent, and can be trained by the training system 200 using any appropriate machine learning techniques. For example, the action selection machine learning model can be implemented, e.g., as a random forest model, a support vector machine model, a linear regression model, or a combination thereof.

As a result of the interactions of the agent with the environment while controlled by the system 100, the system 100 generates actor trajectories 190.

An actor trajectory refers to data characterizing interaction of an agent with an environment over a sequence of one or more time steps. More specifically, for each time step in a sequence of time steps, an actor trajectory can represent: (i) an observation characterizing the state of the environment at the time step, (ii) an action performed by the agent at the time step, and (iii) a reward received at the time step.

An actor trajectory can also represent other data. For example, the actor trajectory can also represent an agent state at each of the time steps. As used in this specification, an agent state at a time step refers to a state of an action selection neural network or other component of the action selection system when processing the observation at the time step. For example, the agent state can include a hidden state of a recurrent action selection neural network, e.g., a cell state of a long short-term memory (LSTM) network), or both. As another example, the agent state can include the data required to replicate the contents of the episodic memory at the time step, e.g., observations at previous time steps or encoded representations of observations at previous time steps. As yet another example, the agent state can include various quantities computed while querying and reading data from an episodic memory or other memory while processing the observation at the time step, e.g., observations at previous time steps or encoded representations of observations at previous time steps.

As another example, the actor trajectory can also include other quantities that have been used by the system 100 to select the action by the given time step. As one example, the agent state can include various quantities computed while performing a look-ahead search of the environment or other planning steps that are incorporated into the action selection process, e.g., that are guided by the outputs of the action selection neural network 104 or that are provided as inputs to the action selection neural network 104. Pre-computing these quantities will be described in more detail below.

The training system 200 trains the network parameters 118 of the action selection neural network 104, e.g., to determine trained values of the network parameters 118 that enable the action selection system 100 to select actions that cause the agent to effectively perform tasks in the environment 110 using the actor trajectories 190.

In some cases, the training system 200 can train the action selection neural network 104 on trajectories generated by simulated instances of agents interacting with simulated instances of the environment. After the training system 200 trains the action selection neural network 104 on the trajectories corresponding to simulated environment interactions, the trained action selection neural network 104 can be used to control interaction of an agent with a real-world environment. Training the action selection neural network based on interactions of the agent with a simulated environment (i.e., instead of a real-world environment) can avoid wear-and-tear on the agent and can reduce the likelihood that, by performing poorly chosen actions, the agent can damage itself or aspects of its environment.

FIG. 2 shows an example training system 200. The training system 200 is an example of a system implemented as computer programs on one or more computers in one or more locations in which the systems, components, and techniques described below are implemented.

The training system 200 implements a framework that allows action selection neural networks or other machine learning models that generate action selection outputs to be effectively trained to control agent to interact with environments.

In particular, the training system 200 can effectively train any of a variety of neural networks to control any of a variety of agents using one or more of a variety of training techniques by implementing a framework that modularizes learning and, optionally, data collection.

In the example of FIG. 2, the training system 200 receives a training request 202 to train an action selection neural network 214 and, in response, trains a set of “global” network parameters 212 of the action selection neural network 214 (e.g., the action selection neural network 104 described with reference to FIG. 1) using reinforcement learning techniques to enable the action selection neural network to select actions to be performed by an agent to effectively accomplish tasks in an environment.

An example of an action selection system that uses an action selection neural network to control an agent interacting with an environment is described in more detail with reference to FIG. 1.

As will be described in more detail below, the system 200 can also train the action selection neural network 214 using supervised learning and/or unsupervised learning in addition to or instead of reinforcement learning.

The training request 202 specifies at least: the architecture of the action selection neural network 214, the loss function that is to be used for the training, and layout data 210 that specifies a learner trajectory layout.

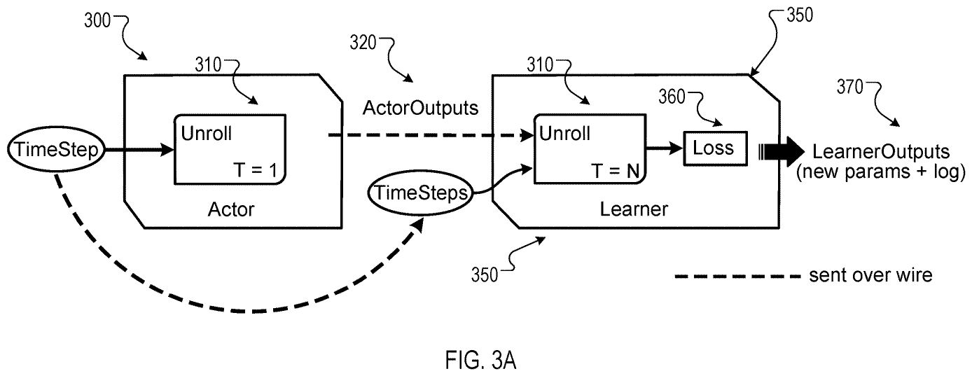

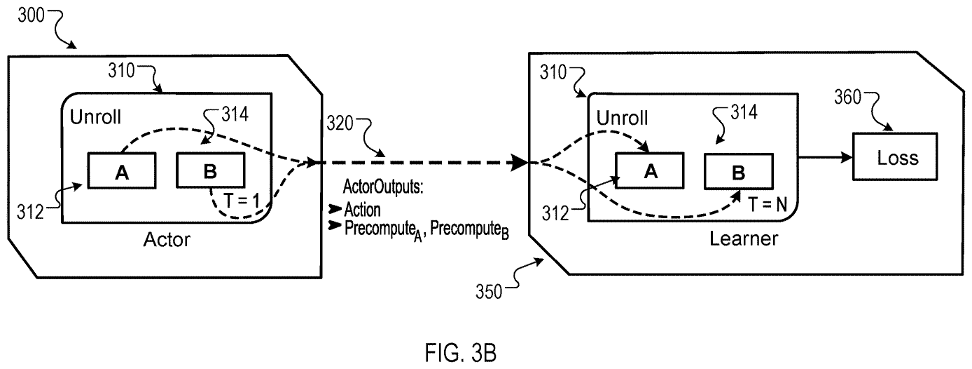

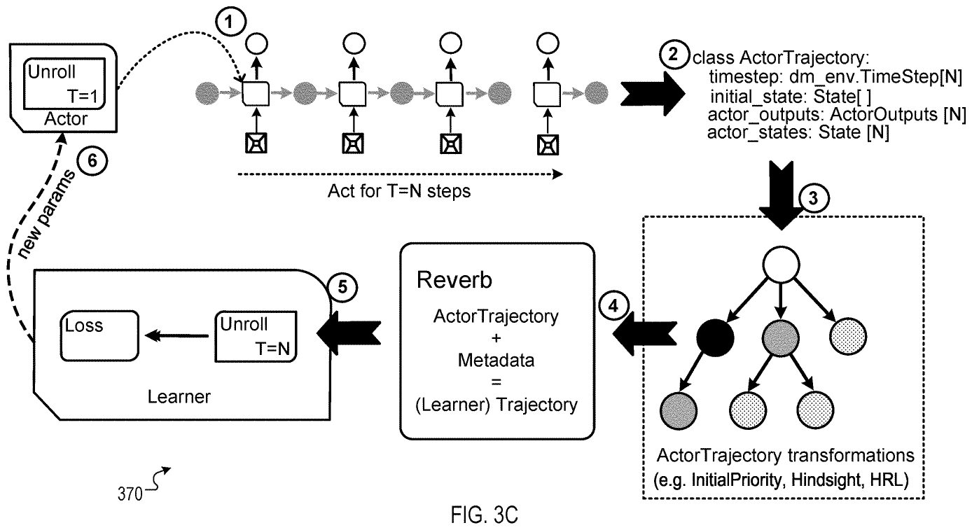

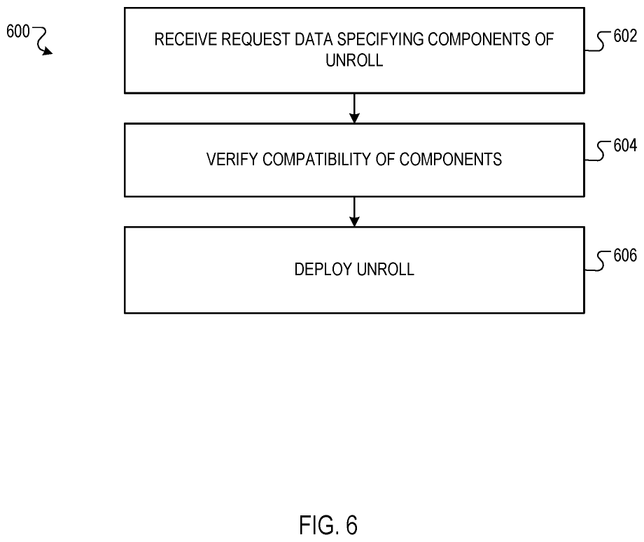

In some implementations, the request 202 specifies the architecture of the neural network 214 and the loss function in a modular fashion, allowing different components of one or both of these to be effectively modified, resulting in different neural networks and different training schemes easily being implemented by the same system 200. This modular specification will be described in more detail below with reference to FIGS. 3A-3C and FIG. 6.

The learner trajectory layout specifies the data that is required to be included in a trajectory so that the trajectory can be ingested by the training process, i.e., so that the trajectory includes sufficient data to compute the loss specified in the request and to compute gradients of the loss with respect to the parameters of the network 214.

Learner trajectory layouts will be described in more detail below.

In the example of FIG. 2, the training system 200 includes a set of one or more actor computing units 204-A-204-N, a learner engine implemented by a set of one or more learner computing units 206, and a modification engine 220, each of which are described in more detail next.

Each of the actor computing units is configured to control interaction of a respective instance of an agent with a respective instance of an environment to generate actor trajectories 216 for use in training the global network parameters 212 of the action selection neural network 214. Each “instance” of the agent can be, e.g., a respective simulated agent interacting with a respective simulated environment, or a respective real-world agent interacting with a respective real-world environment. Two or more of the computing units may be implemented by separate hardware, such as separate computers or separate cores within the same computer.

Each actor computing unit uses a respective action selection system to control a corresponding agent to interact with a corresponding environment, in particular, by selecting a respective action to be performed by the agent at each time step based on an observation of the environment at the time step. At each time step, the agent being controlled by the actor computing unit can receive a respective reward, e.g., characterizing a performance of the agent in accomplishing a task in the environment.

Each actor computing unit can use any appropriate action selection policy to control the interaction of the agent with the environment. For example, each actor computing unit can maintain a respective “actor” action selection neural network having substantially the same neural network architecture as the action selection neural network 214, but with possibly different network parameter values. Using an action selection neural network to select actions to be performed by an agent to interact with an environment is described in more detail with reference to FIG. 1. The training system 200 can periodically update the network parameter values of the actor action selection neural networks maintained by the actor computing units based on the global network parameter values 212, as will be described in more detail below. Each actor computing unit can also implement a respective exploration policy as part of controlling the interaction of the agent with the environment, e.g., each actor computing unit can implement an ϵ-greedy exploration policy (as described above) with a different value of ϵ.

In some examples, instead of or in addition to using actor trajectories generated by actors controlled by the system 200, the system 200 trains using data generated by one or more other systems.

For example, the system 200 can train using actor trajectories generated by another system. This type of actor trajectory data set is referred to as “off-line data” because it was not generated “on-line” using the neural network 214 being trained by the system 200. The other system may be implemented on a different data processing apparatus to that on which the system 200 is implemented and may be a remote system.

As another example, the system 200 can train on a different type of dataset. For example, the system 200 can use an image data set to pre-train an encoder neural network within the action selection neural network, e.g., before training the neural network “on-line” or “off-line” on actor trajectories.

Prior to using the actor trajectories 216 to train the neural network 214, the modification engine 220 transforms each actor trajectory 216 into a corresponding learner trajectory 222. The learner trajectories 222 are then provided as input to the learner engine for use in training the neural network 214.

In particular, the modification engine 220 uses the layout data 210 to transform each actor trajectory 216 from the actor layout to the learner layout that is specified by the layout data 210.

In particular, the modification engine 220 modifies the actor trajectories to include information required to train the neural network and to remove information that is not required to train the neural network.

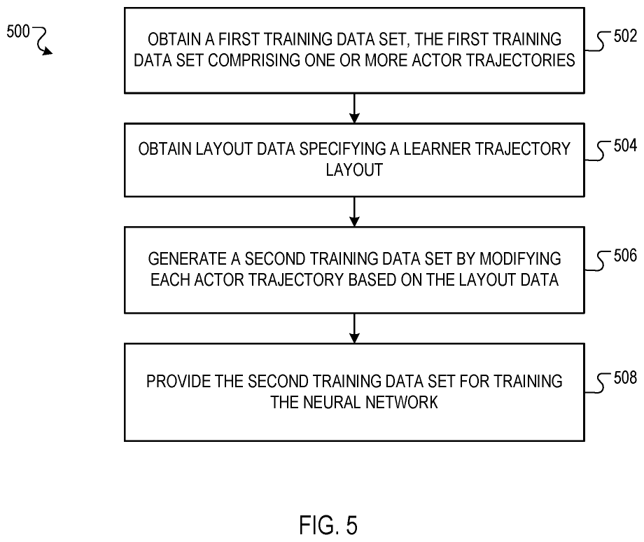

The operations of the modification engine 220 are described in more detail below with reference to FIG. 5.

While FIG. 2 shows a single modification engine 220, in some cases, each actor computing unit includes a respective modification engine 220 that transforms the actor trajectories generated by that computing unit before those trajectories are stored in a replay memory or provided directly to the learner engine.

As described above, in some implementations, the training system 200 stores the learner trajectories 222 in a replay memory. The learner engine can then sample learner trajectories 222 instead of actor trajectories 216 from the replay memory for use in training the neural network.

In some other implementations, the training system 200 stores the actor trajectories 216 in the replay memory, and the modification engine 220 transforms each actor trajectory 216 that is sampled from the replay memory into a learner trajectory 222 before those trajectories are provided to the learner engine.

The learner engine is configured to train the global network parameters 212 of the action selection neural network 214 using reinforcement learning techniques based on the learner trajectories. For example, each learner computing unit 206 can maintain a respective learner action selection neural network having substantially the same architecture as the action selection neural network 214. To update the global network parameters 212, a learner computing unit can set the parameter values of its learner action selection neural network equal to the current values of the global network parameters 212. The learner computing unit can then sample (e.g., randomly sample) one or more learner trajectories 222 from the replay memory (or obtain the learner trajectories directly from one of the actors), and train the learner action selection neural network on the sampled trajectories using reinforcement learning techniques to update the parameter values of the learner action selection neural network. The learner computing unit can then update the global network parameters 212, e.g., by setting the global network parameters equal to a weighted average of the: (i) the current global network parameters 212, and (ii) the updated parameters of the learner action selection neural network.

The learner computing units 206 can be configured to operate synchronously or asynchronously. In an asynchronous configuration, the learner computing units operate independently of one another in determining updates to the global network parameters 212 of the action selection network 214. An asynchronous implementation may be particularly suited to exploiting a distributed training system 200, to facilitate greater parallelization. That is, in an asynchronous implementation, a learner computing units need not wait for any other learner computing unit to update the global network parameters 212. In a synchronous configuration, at each of multiple training iterations, the learner computing units determine updates to the global network parameters 212 of the action selection neural network 214 based on the same current global network parameter values 212. The parameter updates generated by each of the learner computing units are jointly applied to the global network parameter values 212 at the end of each training iteration.

The training system 200 can periodically update the network parameter values of the actor action selection neural networks maintained by the actor computing units based on the current global network parameter values 212. For example, the training system 200 can update the network parameter values of an actor action selection neural network being maintained by an actor computing unit whenever the training system determines that an update criterion has been satisfied for the actor action selection neural network. The training system 200 can determine that an update criterion has been satisfied for an actor action selection neural network, e.g., if the actor action selection neural network has controlled the agent for more than a threshold number of time steps since its network parameter values were last updated. The threshold number of time steps can be, e.g., 500 time steps, 1000 time steps, or any other appropriate number of time steps. By waiting until an update criterion has been satisfied, the training system 200 can avoid unnecessary and costly transmission of data between actor computing units and the network parameter values 212.

An actor computing unit can use the current values of the global network parameters 212 to update the current values of its actor action selection network parameters in any appropriate manner. For example, the actor computing unit can replace the current values of its actor action selection network parameters with the current values of the global network parameters. As another example, the actor computing unit can replace the current values of its actor action selection network parameters by a linear combination of the current values of the actor action selection network parameters and the global network parameters.

FIG. 3A illustrates an example of an actor engine 300 and a learner engine 350.

As shown in FIG. 3A, the actor engine 300 defines the process of data collection for the training of the neural network based on the data in the training request 202. That is, the actor engine 300 is one of one or more actor engines that generates actor trajectories for use in training the neural network in accordance with the training request 202.

Similarly, the learner engine 350 defines the training of the neural network based on the data in the training request 202.

In the example of FIG. 3A, the training request specifies an unroll 310 that is deployed as part of both the actor engine 300 and the learner engine 350 and a loss component 360 to e used for the training.

An “unroll” is a collection of software components that, when deployed by the actor engine 300, cause the actor engine 300 to perform operations to act in the environment to generate actor outputs 320 and, when deployed by the learner engine 350, cause the learner engine 350 to perform operations to compute a loss 360 that is used to generate learner outputs 370.

The actor outputs 320 include the data required to generate an actor trajectory. Thus, the actor outputs 320 generally include, at each time step, data identifying the observation at the time step, the action at the time step, the reward received at the time step, and the agent state at the time step. In some cases, and as described below, the actor outputs 320 can also include pre-computed values that are used by the learner engine 350 when training on the corresponding learner trajectory.

The loss component 360 takes as input the output of the unroll 310 when operating on a learner trajectory and, optionally, data from the learner trajectory directly and generates the learner outputs 370. That is, the loss component 360 uses these inputs to compute gradients of a loss function and use the gradients to generate updated parameters of the action selection neural network. While only a loss component 360 is shown in the example of FIG. 3A, in some implementations, the request also specifies an optimizer component that specifies the optimizer that is applied to gradients computed by the loss component 360 to map the gradients to new parameter values. Optionally, the loss component 360 can also output logged values for use in tracking the training of the action selection neural network, e.g., individual loss values for learner trajectories or observations within the learner trajectories or outputs of other intermediate computations that can be useful for monitoring the performance of the training process. The loss function can be any appropriate loss function that is specified by a user of the system, e.g., a loss function that is made up of one or more of a reinforcement learning loss, a supervised learning loss, or an unsupervised learning loss. That is, the loss component 360 can be used to train the action selection neural network on a combination of multiple different losses, e.g., a combination of a main loss for a task and one or more auxiliary losses.

More specifically, the unroll 310 specifies the components of the action selection neural network that are required to select an action at a given time step, to compute an input to the loss component 360 for the given time step, or both.

As A one example, the unroll 310 can separately specify three components of the action selection neural network: an encoder, a memory, and a policy.

The encoder specifies the component of the neural network that processes the current observation to generate an encoded representation of the current observation. Examples of encoders include various convolutional neural network architectures, e.g., ResNets, various Transformer architectures, e.g., Vision Transformers, and various fully-connected neural network architectures, e.g., multi-layer perceptrons (MLPs).

The memory specifies the memory component used by the neural network. In some cases, the neural network may not make use of a memory component, and the training request can specify that the memory component is the identity transformation applied to representation generated by the encoder. Examples of memory components can include recurrent neural networks, Transformers, or episodic memories as described above.

The policy specifies (i) the component of the neural network that processes the encoded representation or the output of the memory component to generate the policy output that is used to select the action and (ii) the software component that maps the policy output to a selected action. For example, the neural network component of the policy can be an MLP or another collection of neural network layers. The software component that maps the policy output to a selected action can be a component that implements a greedy policy or an exploratory policy, e.g., epsilon greedy or another exploration technique for exploring the environment.

By specifying these (and, optionally, other components of the neural network) in a modular fashion, i.e., because the unroll separately specifies each of the components of the action selection neural network, a user can easily modify the unroll 310 by modifying one or more of these components to modify the training scheme being used to train the neural network, the architecture of the neural network, or the policy that is used to control the agent. In particular, by making a single modification to one of the modular components within the unroll 310, a user can effectively modify the operations performed by both the actor 300 and the learner 350 so that matching computations are performed for both training data generation and for training on the generated training data.

While the example of FIG. 3A shows a single loss component, in some cases the learner engine may use (and the request may therefore specify) multiple losses to train the neural network.

Additionally, while the above example describes three components of the action selection neural network, for more complex agents more components may be specified.

Examples of such additional components include MCTS components, decoder neural networks, and so on.

As shown in FIG. 3A, when deployed on the actor 300, the components of the unroll operate a time scale of T=1, i.e., generate a respective actor output at each time step so that the agent can be controlled at the time step. However, when deployed on the learner 350, the components of the unroll 310 can operate at time scale of T=N, where N is the number of time steps in the trajectory. That is, because all of the actor outputs are available at all N time steps, the unroll 310 can operate on all N time steps in parallel in order to compute the requisite inputs to the loss component 360. In this way, a learner that is implemented over a plurality of computing units can use the plurality of processing units to perform the learning in parallel. For example, for a learner with N computing units, the unroll 310 could operate on each of the N time steps using an individual computing unit in parallel.

FIG. 3B shows another example of the actor engine 300 and the learner engine 350.

In the example of FIG. 3B, the unroll 310 includes two components A 312 and B 314. For example, the component A can be an encoder of the action selection neural network and component B can be the policy used by the action selection neural network.

As shown in FIG. 3B, when executing on the actor 300, the components A 312 and B 314 each pre-compute respective values and these pre-computed values are sent to learner 350, e.g., by being stored as part of the actor trajectory that is generated using the actor outputs 320. That is, the actor outputs 320 include, at each time step, the action selected at the time step and respective pre-computed values for component A and component B.

When the unroll 310 is deployed on the learner engine 350, the components A 312 and B 314 are configured to either (i) use the pre-computed values as part of generating their respective outputs or (ii) when the pre-computed values are the outputs of the components, provide the pre-computed values as output instead of performing the operations

That is, the user can configure the unroll 310 such that “precompute” is enabled for certain quantities on the actor 300. Thus, these quantities will be saved as part of the actor (and learner) trajectories rather than being discarded after they are computed. When the unroll 310 is deployed on the learner 350, the learner 350 can fetch these pre-computed quantities in order to save computation. As described below, given the resource-intensive nature of some of the unroll components, it is better to use additional memory resources to store the precomputed quantities than to expend the time, energy, and processor cycles required to compute those quantities during learning.

Some examples of quantities that can be configured to be precomputed are described below.

In some implementations, the unroll can include a look-ahead search component, e.g., MCTS, that performs a look-ahead search through states of the environment or a latent state space representing states of the environment, the output of which is provided to the action selection neural network or which is guided by the action selection neural network and then used to select the action at a given time step. Examples of such components include MuZero and AlphaZero, to name a few. This look-ahead search can be computationally expensive. Therefore, the system can run the expensive search only during acting and reuse the results during learning by causing the unroll to precompute the results on the actor and having the corresponding component on the learner make use of the pre-computed results.

As another example, querying the episodic memory can require an expensive kNN (k nearest neighbors) lookup across all of the data items in the episodic memory. The system can avoid this lookup during learning by reusing the memory reads computed by the unroll while acting.

As yet another example, when computing intrinsic rewards for exploration (e.g., via Random Network Distillation or another technique that computes rewards that reward the system for exploring the environment), the system can perform the computation during acting, and reuse the pre-computed intrinsic reward when learning.

FIG. 3C shows an example 370 of the flow of data between actor engines and learner engines.

As can be seen from FIG. 3C, at step 1, the actor engine “acts”, i.e., controls the agent, for T=N time steps using the unroll deployed on the actor engine.

At step 2, the actor engine generates an actor trajectory that includes, at each of the N time steps, the observation received from the environment at the time step, the initial state of the action selection neural network (and other components of the unroll) prior to the first time step, the state of the action selection neural network at the time step, the actions performed at each of the N time steps, and the respective states of the action selection neural network after each of the N time steps.

At steps 3 and 4, transformations are applied to the actor trajectory to generate a learner trajectory before the trajectory is stored in a replay memory that is implemented using a data storage and transport system (e.g., the Reverb system). In particular, at step 3, transformations are applied to the actor trajectory using one or more learner layouts and at step 4, metadata from the replay memory is added to the trajectory to generate the final learner trajectory.

At step 5, the learner engine samples the learner trajectory from the replay memory and uses the unroll and the loss components to generate new parameters for the action selection neural network (and any other learned components of the unroll).

At step 6, the new parameters are provided to the actor engine for updating the unroll before the actor engine generates new actor trajectories.

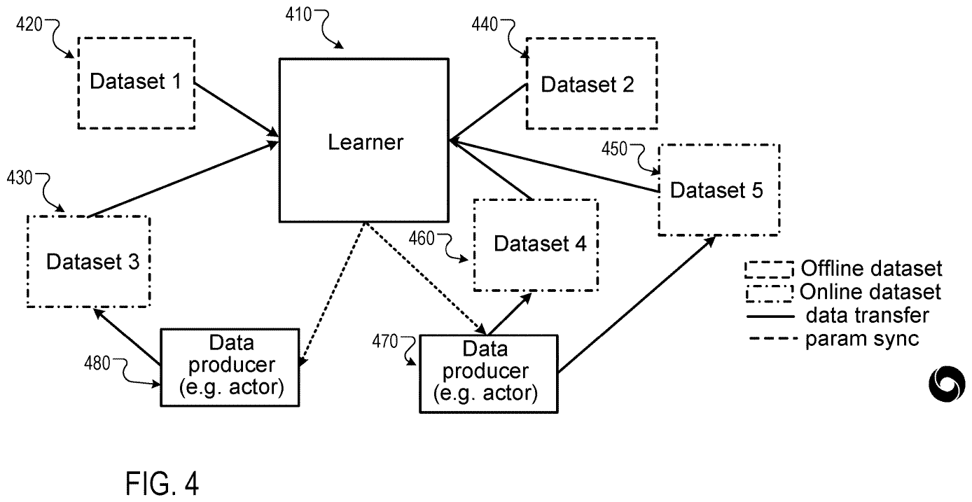

FIG. 4 shows a learner engine 410 training a neural network on multiple different data sets.

As described above, while the example of FIG. 2 shows a learner engine training a neural network on a single training data set of actor trajectories being generated by actors controlled by the training system, by making use of the layout data, the same learner engine 410 can train the neural network on multiple different data sets generated by multiple different sources.

In particular, although the different sources may generate differently formatted actor trajectories, the training system can use the layout data to transform each actor trajectory that is being used to train using a given loss to the same learner layout.

As shown in the example of FIG. 4, the learner engine 410 trains neural network on five different data sets 420, 430, 440, 450, and 460. Two of the datasets 430 and 460 are “on-line” datasets that are generated through interactions of an agent being controlled by the same neural network that is being trained by the learner engine 410. As a result, the learner engine 410 periodically provides parameter values (performs a “param sync”) to respective data producers 480 and 470 that are generating the data sets 430 and 460, respectively. Three of the datasets 420, 440, and 450 are “off-line” data sets that were generated as a result of controlling the agent using a different system or by an expert agent, e.g., a human. For these data sets, the learner engine 410 does not perform any param syncs.

In some implementations, the learner engine 410 can use multiple different losses during the training of the neural network. As one example, the learner engine 410 can pre-train some components of the neural network using an unsupervised learning loss and then train the entire neural network through reinforcement learning. As another example, the learner engine 410 can use an unsupervised representation learning loss to train some components of the neural network while training other components or the entire neural network through reinforcement learning. As yet another example, the learner engine 410 can train the neural network both through supervised learning, e.g., through behavior cloning, and reinforcement learning, e.g., through imitation learning.

In these implementations, the training system can use multiple different learner layouts, e.g., a respective learner layout for each different loss function that is being used for the training. Therefore, the training system can generate multiple different types of learner trajectories from the same data set or use different learner layouts for different data sets. For example, the training system 410 can use a layout for an unsupervised learning loss to generate learner trajectories for the off-line data sets 420, 440, and 450 while using a layout for a reinforcement learning loss to generate learner trajectories for the on-line data sets 430 and 460.

FIG. 5 is a flow diagram of an example process 500 for training an action selection neural network used to select actions to be performed by an agent interacting with an environment. For convenience, the process 500 will be described as being performed by a system of one or more computers located in one or more locations. For example, a training system, e.g., the training system 200 of FIG. 2, appropriately programmed in accordance with this specification, can perform the process 500.

The system obtains a first training data set (step 502). The first data set includes one or more actor trajectories generated according to an actor trajectory layout. For example, the first data set can be an “on-line” data set being generated using the action neural network. As another example, the first data set can be an “off-line” data set that was generated by controlling an agent using a different policy.

The system obtains layout data specifying a learner trajectory layout (step 504). The layout data may be included in a training request for training the neural network.

The system generates a second training data set by modifying each actor trajectory based on the layout data to have the learner trajectory layout (step 506). For example, step 506 can be performed locally on the actor computing unit that generated the first data set or can be performed by an intermediary computing unit that is communicatively coupled between the actor computing unit and a replay memory or a learner engine that performs the training.

Some examples of modifications that can be applied by the system now follow.

As one example, the actor trajectory may include “agent state” data that is necessary to produce data, i.e., to act in the environment, but that is not necessary for learning from the trajectory. For example, the agent state data can include hidden states of recurrent layers within the action selection neural network. While this data is required to be maintained for acting, it may need to be re-computed for learning due to different parameter values of the neural network when the trajectory is sampled from the replay memory. Even if the data does not need to be re-computed, providing the respective agent state for each time step in a trajectory may require significant network bandwidth to be transmitted from the replay memory to the learner and may consume excessive memory when stored at the learner. Thus, in this example, to reduce physical resource usage the system can modify each actor trajectory by removing the agent state data for all time steps after the first time step. That is, while the actor trajectory can include all of the agents states for all of the time steps, the learner trajectory can include only the first agent state that is required to accurately initialize the processing of the learner (to match the initial state of the actor when the trajectory was generated).

In some implementations, the system can also add data to the trajectory as part of transforming the trajectory from an actor trajectory to a learner trajectory. For example, the system can add metadata from the replay buffer to each learner trajectory. For example, the system can add one or more of: priorities of each trajectory in the sampled batch, number of times each trajectory has been sampled, and so on.

As another example, when the actor computing units use episodic memory when controlling the agent as described above, the actors maintain very large memory states that are included in the agent trajectory as part of the agent state. However, when training on a trajectory, at any given time step, the learner engine only needs to access the results of querying the episodic memory at the time step. Therefore, the system can modify the actor trajectory to include the query results at each time step. In so doing, the system avoids needing to recompute the query results while at the same time avoiding transmitting the entire large memory state.

As another example, the learner engine may require certain data computed by the actor in order to compute a loss during training. In this example, the actor can “pre-compute” this data and then the system can include the pre-computed data in the learner trajectory. As one example, when a look-ahead search is used during acting, the actor computes a policy output over a set of actions from the current state of the environment by performing the look-ahead search. This policy output can be necessary for the learner engine in order to compute a “target” action selection output when training the neural network. The system can modify the actor trajectory to include, for each time step, the policy output that was generated by performing the look-ahead search. This prevents the learner engine from having to re-compute this output when training on a trajectory.

More specifically, when the unroll described above is deployed on the actor, the output of the look-ahead search component is stored and added to the actor trajectory. When the unroll is deployed on the learner, the output of the look-ahead search component is retrieved and re-used from the corresponding learner trajectory, e.g., re-used by the loss component, without needing to be re-computed.

As another example, the learner engine may be training a hierarchical RL agent. A hierarchical RL includes at least two levels of machine learning models, with the lowest level generating control signals for the agent, and each higher level generating inputs to the next lowest level. In this example, the agent trajectory may include only actual outputs for the lowest-level model, i.e., only the control inputs for the agent. The system can modify the agent trajectory to include ground truth outputs for each level of the hierarchy, preventing the learner engine from needing to recompute these actual outputs during learning.

As yet another example, the loss being used by the learner engine may generate modified rewards for a given time step based on the reward at the time step and rewards, actions, or observations received and/or predicted outputs generated many time steps in the future. That is, the loss depends on a modified reward for the time step that, in turn, is dependent on data from temporally distance time steps. In this example, the system can modify the agent trajectory to include not only the immediate reward but can also compute the modified reward. That is, because the entire task episode is available on the actor computing unit, the actor computing unit can effectively compute the modified rewards for the time steps and include the modified rewards in the actor trajectory.

The system provides the second training data set for training the neural network (step 508). For example, the system can store the second training data set in a replay memory, e.g. for later use by a learner engine in training the neural network using the corresponding loss function.

Alternatively, as described above, the system can instead store the actor trajectories in the replay memory and then perform the process 500 to transform actor trajectories into learner trajectories each time a trajectory is sampled from the replay memory.

FIG. 6 is a flow diagram of an example process 600 for configuring a modular unroll. For convenience, the process 600 will be described as being performed by a system of one or more computers located in one or more locations. For example, a training system, e.g., the training system 200 of FIG. 2, appropriately programmed in accordance with this specification, can perform the process 600.

As used in this specification, an unroll is the software component that maps observations of the environment to the quantities required to control the agent and to update the learnable parameters of the unroll, i.e., of the action selection neural network and, optionally, of any auxiliary components that are used to improve the training of the action selection neural network, e.g., value neural network heads, computation of auxiliary losses, computations of learned rewards, and so on.

The system receives request data that specifies the components of the unroll (step 602). For example, the system can receive the request through an application programming interface (API) provided by the system. The request data can specify, for example, any of the components above that make up the action selection neural network and optionally one or more auxiliary components.

As another example, the request data can modify one or more of the components in an existing unroll, e.g., change the memory employed by the existing unroll, e.g., to or from no memory, recurrent memory, transformer memory, and so on without changing any other part of the architecture.

The system verifies the compatibility of the components of the unroll with one another (step 604). For example, the system can verify whether the components specify a memory component and, if not, whether any of the other components receive an input from a memory component. For example, the request may specify a decoder neural network or a policy head that receives as input a state representation generated by a memory component. In response to determining that the components are not compatible, the system can insert one or more additional components to confer compatibility. For example, the system can insert a pass-through memory component that represents the identity transformation.

The system deploys the unroll on the actor engine(s) and the learner engine(s) within the system (step 606). As described above, the system can deploy the unroll differently on the actor than on the learner, e.g., so that the unroll operates at different time scale and with different settings for generating or operating on precomputed values.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more data processing apparatus for training a neural network for use in controlling an agent interacting with an environment, the method comprising:
obtaining a first training data set, the first training data set comprising a plurality of first actor trajectories generated according to a first actor trajectory layout;
receiving a training request for training the neural network, the training request comprising layout data specifying a learner trajectory layout;
generating a second training data set by modifying each first actor trajectory based on the layout data to have the learner trajectory layout; and
providing the second training data set for use in training the neural network.

2. The method of claim 1, wherein providing the second training data set for use in training the neural network comprises:
storing the second training data set in a replay memory.

3. The method of claim 1, wherein the first training data is stored in a replay memory, and wherein generating a second training data set comprises:
sampling, from the replay memory, a batch of first actor trajectories from the first training data set; and
modifying each first actor trajectory in the batch based on the layout data to have the learner trajectory layout.

4. The method of claim 1, wherein obtaining a first training data set comprises, for each of one or more actor engines, repeatedly performing operations comprising:
controlling an instance of the agent to interact with the environment using an instance of the neural network; and
generating a corresponding first actor trajectory based on the interaction of the instance with the environment.

5. The method of claim 4, further comprising, for each of one or more learner engines, repeatedly performing operations comprising:
obtaining a batch of first actor trajectories; and
training the neural network on the batch of first actor trajectories to minimize a loss function.

6. The method of claim 5, wherein the training request specifies:
an unroll that comprises neural network components of the neural network to be deployed on both the one or more learner engines and the one or more actor engines, wherein the unroll:
when deployed on the one or more actor engines, performs operations to generate an actor output for controlling the instance of the agent from an observation characterizing a state of the environment, and
when deployed on the one or more learner engines, performs operations to generate a learner output for evaluating the loss function.

7. The method of claim 6, wherein the training request specifies:
a loss component that is deployed on the one or more learner engines and that receives an input comprising the learner output from the unroll deployed on the learner engine and determines an update to parameters of the neural network.

8. The method of claim 6, wherein:
the training request designates, as pre-compute values, a subset of values that are computed by the unroll when deployed on the actor engines to generate an actor output,
the unroll, when deployed on the actor engines, stores the pre-compute values as part of the actor trajectory, and
the unroll, when deployed on the learner engines, accesses the pre-compute values rather than re-computing corresponding values while generating learner outputs.

9. The method of claim 6, wherein:
the unroll, when deployed on the actor engines, operates on each received observation independently to generate a respective actor output for each observation, and
the unroll, when deployed on the learner engines, operates on a plurality of time steps from each learner trajectory jointly to generate a learner output for the plurality of time steps.

10. The method of claim 1, further comprising:
obtaining a third training data set, the third training data set comprising a plurality of third actor trajectories generated according to a third, different actor trajectory layout;
generating a fourth training data set by modifying each third actor trajectory based on the layout data to have the learner trajectory layout; and
providing the fourth training data set for use in training the neural network.

11. The method of claim 1, wherein the training request further specifies a respective architecture of one or more components of the neural network.

12. A system comprising one or more computers and one or more storage devices storing instructions that when executed by the one or more computers cause the one more computers to perform operations for training a neural network for use in controlling an agent interacting with an environment, the operations comprising:
obtaining a first training data set, the first training data set comprising a plurality of first actor trajectories generated according to a first actor trajectory layout;
receiving a training request for training the neural network, the training request comprising layout data specifying a learner trajectory layout;
generating a second training data set by modifying each first actor trajectory based on the layout data to have the learner trajectory layout; and
providing the second training data set for use in training the neural network.

13. (canceled)

14. The system of claim 12, wherein providing the second training data set for use in training the neural network comprises:
storing the second training data set in a replay memory.

15. The system of claim 12, wherein the first training data is stored in a replay memory, and wherein generating a second training data set comprises:
sampling, from the replay memory, a batch of first actor trajectories from the first training data set; and
modifying each first actor trajectory in the batch based on the layout data to have the learner trajectory layout.

16. The system of claim 12, wherein obtaining a first training data set comprises, for each of one or more actor engines, repeatedly performing operations comprising:
controlling an instance of the agent to interact with the environment using an instance of the neural network; and
generating a corresponding first actor trajectory based on the interaction of the instance with the environment.

17. The system of claim 16, the operations further comprising, for each of one or more learner engines, repeatedly performing operations comprising:
obtaining a batch of first actor trajectories; and
training the neural network on the batch of first actor trajectories to minimize a loss function.

18. The system of claim 17, wherein the training request specifies:
an unroll that comprises neural network components of the neural network to be deployed on both the one or more learner engines and the one or more actor engines, wherein the unroll:
when deployed on the one or more actor engines, performs operations to generate an actor output for controlling the instance of the agent from an observation characterizing a state of the environment, and
when deployed on the one or more learner engines, performs operations to generate a learner output for evaluating the loss function.

19. The system of claim 17, wherein the training request specifies:
a loss component that is deployed on the one or more learner engines and that receives an input comprising the learner output from the unroll deployed on the learner engine and determines an update to parameters of the neural network.

20. The system of claim 18, wherein:
the training request designates, as pre-compute values, a subset of values that are computed by the unroll when deployed on the actor engines to generate an actor output,
the unroll, when deployed on the actor engines, stores the pre-compute values as part of the actor trajectory, and
the unroll, when deployed on the learner engines, accesses the pre-compute values rather than re-computing corresponding values while generating learner outputs.

21. One or more non-transitory computer storage media storing instructions that when executed by one or more computers cause the one more computers to perform operations for training a neural network for use in controlling an agent interacting with an environment, the operations comprising:
obtaining a first training data set, the first training data set comprising a plurality of first actor trajectories generated according to a first actor trajectory layout;
receiving a training request for training the neural network, the training request comprising layout data specifying a learner trajectory layout;
generating a second training data set by modifying each first actor trajectory based on the layout data to have the learner trajectory layout; and
providing the second training data set for use in training the neural network.
